(19) United States
(12) Patent Application Publication
(10) Pub. No.: US 2007/0143939 A1
(43) Pub. Date: Jun. 28, 2007

(54) HYGIENE FOR BODY PIERCINGS

(75) Inventor: Marc Zocher, Bainbridge Island, WA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: BioSara Corporation, Bainbridge Island, WA (US)

(21) Appl. No.: 11/614,600

(22) Filed: Dec. 21, 2006

Related U.S. Application Data
(60) Provisional application No. 60/753,487, filed on Dec. 23, 2005.

(51) Int. Cl. B08B 1/00

(52) U.S. Cl. 15/104.92

(57) ABSTRACT

A cleaning apparatus for a body piercing includes an elongated applicator having a substantially rigid proximal end, a treatment to be applied to the applicator, and a grip through which the applicator proximal end extends. The grip is used to guide the applicator proximal end into one side of the body piercing and out the other side, and the proximal end of the applicator is pulled from the grip through the body piercing. As the applicator is pulled from the grip and through the body piercing, the treatment is applied to the applicator and then to the body piercing. The body piercing is thereby cleansed and treated. The applicator is packaged to remain sterile until use and the cleaning apparatus is easily carried about.

This application claims priority of co-pending U.S. Provisional Patent Application Ser. No. 60/753,487 entitled “Hygiene for Body Piercings” by M. Zocher, filed Dec. 3, 2005. Priority of the filing date of Dec. 23, 2005 is hereby claimed, and the disclosure of the Provisional Patent Application is hereby incorporated by reference.

### BACKGROUND OF THE INVENTION

1. Field of the Invention

The present invention relates generally to personal hygiene and, more particularly, to cleaning and medication of body piercings.

2. Description of the Related Art

The invention is directed to personal hygiene and application of medical topical solutions, and specifically to aftercare for a body piercing, such as a pierced ear and the like. Body piercings are becoming more widespread in the popular culture and are becoming accepted as aesthetically pleasing. Piercings are applied to the ears, nose, eyebrows, tongues, and assorted folds of skin. A decorative stud and clasp combination is typically inserted through the body piercing.

Because a piercing is an open wound to the skin, it is important to keep body piercings clean, especially in the time immediately following the piercing procedure. Keeping the body piercing clean promotes healing and prevents infection of the wound. In general, cleaning techniques for body piercings have involved an assortment of materials and supplies that are comprise a cleaning kit that must be assembled whenever a piercing is to be cleaned. Cleaning kits for piercing aftercare typically include a cleaning solution, a cleaning material to which the solution is applied, an insertion tool to pull the cleaning material through the body piercing, and a container to hold all the materials. The cleaning solution is typically an antiseptic or medicating agent contained in a bottle or other sealed vessel. The cleaning material is usually a sterile pad or a thread or string that is soaked with the cleaning solution. The insertion tool often resembles a sewing needle, having an eye that receives the string such that the needle can be pushed through the body piercing and the string can be threaded through the piercing.

After the string is soaked in the solution, the string is threaded through the eye of the needle, which is then pulled through the piercing. The needle brings the soaked string with it through the piercing. The soaked string makes contact with the piercing and thereby cleans it. The string can then be disposed of and the kit supplies can be put away. The process of soaking the string, threading the string through the needle and then pulling it through body piercing, and then cleaning up and disposing of the used supplies afterwards, is inconvenient. Moreover, it can be cumbersome to carry around the cleaning kit supplies and it can be a challenge to ensure sterility of the kit.

It would be advantageous if aftercare for body piercings could be easily transported but yet maintained sterile until use, and then easily disposed of to maintain sanitary conditions. Thus, there is a need for more convenient, transportable, and sterile aftercare for body piercings. The present invention satisfies this need.

### SUMMARY

A body piercing is cleaned with a cleaning apparatus that includes an elongated applicator having a substantially rigid proximal end, a treatment to be applied to the applicator, and a grip through which the applicator proximal end extends such that the grip can be grasped and used to guide the applicator proximal end into one side of the body piercing and out through a second side of the body piercing such that the proximal end can be grasped from the second side and pulled from the grip. The treatment is contained in the grip such that the treatment is applied to the applicator as the applicator is pulled from the grip, and the treatment is applied to the body piercing as the applicator is pulled through the body piercing.

The body piercing is thereby cleansed and treated. After the cleaning apparatus is used, it can be disposed of. In an alternative construction, a reusable holder is provided, into which the applicator/grip/treatment combination can be inserted and disposed of after each use while the holder is retained for future use. The applicator is packaged to remain sterile until use and the cleaning apparatus is easily carried about.

There are a variety of configurations for the grip, including a disposable version and a version with a reusable holder that receives a disposable insert that can comprise the disposable version grip. The different configurations can include a torus-shaped or disk-shaped version, and a cylindrical or hourglass shaped version. Both torus and cylindrical versions can be provided alone in a disposable configuration or for use with a reusable holder of like shape.

Other features and advantages of the present invention should be apparent from the following description of the preferred embodiment, which illustrates, by way of example, the principles of the invention.

### BRIEF DESCRIPTION OF THE DRAWINGS

FIG. 1 is a perspective view of a cleaning apparatus and container packet embodiment that are constructed in accordance with the present invention.

FIG. 2 is a cross-section view of the FIG. 1 apparatus.

FIG. 3 is an illustration of another embodiment of the cleaning apparatus, shown in phantom to illustrate the coiled applicator thread.

FIG. 4 is a perspective view of a cleaning apparatus embodiment with a release button for the treatment.

FIG. 5 is a cross-section view of the FIG. 4 apparatus.

FIG. 6 is a perspective view of another cleaning apparatus embodiment, this one having a torus shape.

FIG. 7 is a cross-section of the FIG. 6 apparatus showing the treatment bladder.

FIG. 8 is a perspective view of the FIG. 7 apparatus with a reusable dispenser.

FIG. 9 is an illustration of the applicator coiled in loops within a cylindrical grip.

FIG. 10 is an illustration of the applicator contained within tubing that is coiled on itself.

FIG. 11 shows a “foil pack” embodiment 1102 constructed for convenient usage within the compact or holder illustrated in FIG. 8.

In the drawings, like reference numerals refer to like structures.

### DETAILED DESCRIPTION

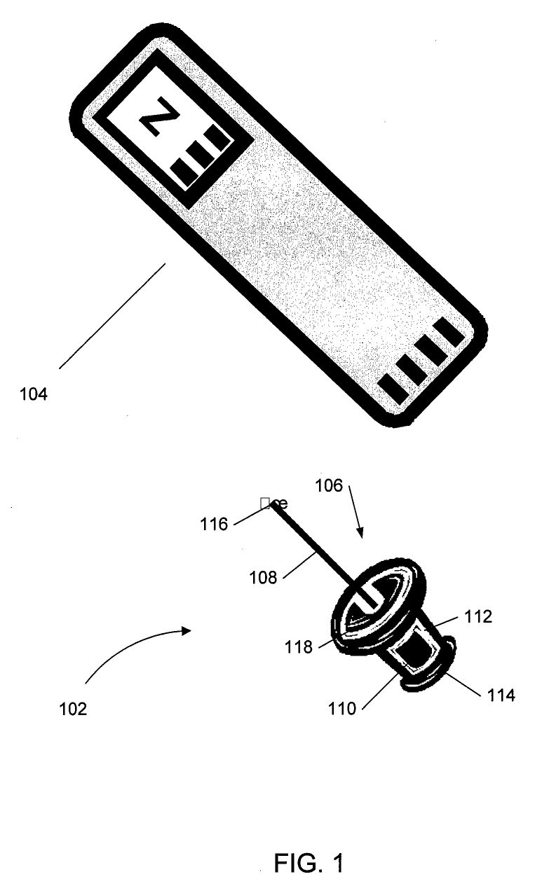

FIG. 1 is a perspective view of a cleaning apparatus 102 and container packet 104 embodiment that are constructed in accordance with the present invention. The cleaning apparatus 102 is enclosed within the packet 104 until the cleaning apparatus is to be used, at which time the packet is opened and the cleaning apparatus is removed. A body piercing is cleaned with the cleaning apparatus, which includes an elongated applicator 106 having a substantially rigid proximal end 108 and a flexible distal portion 110, a treatment 112 to be applied to a body piercing by the applicator, and a grip 114 through which the applicator proximal end extends. The substantially rigid proximal end 108 of the applicator has a rounded shape 116 so as to avoid any sharp edge or corner that might cut or scratch the skin. A substantially flat, planar surface 118 of the grip provides a surface that can be placed against a user's ear or other skin surface surrounding the piercing to be cleaned or medicated with the treatment, thus helping to preserve sterility of the applicator. The treatment 112 can be an aqueous solution or can be a powder or other substance to be applied to the applicator 106, and can incorporate medication or other topical solutions. Keeping the apparatus 102 within the packet 104 until use ensures sterility of the product and prolongs shelf life.

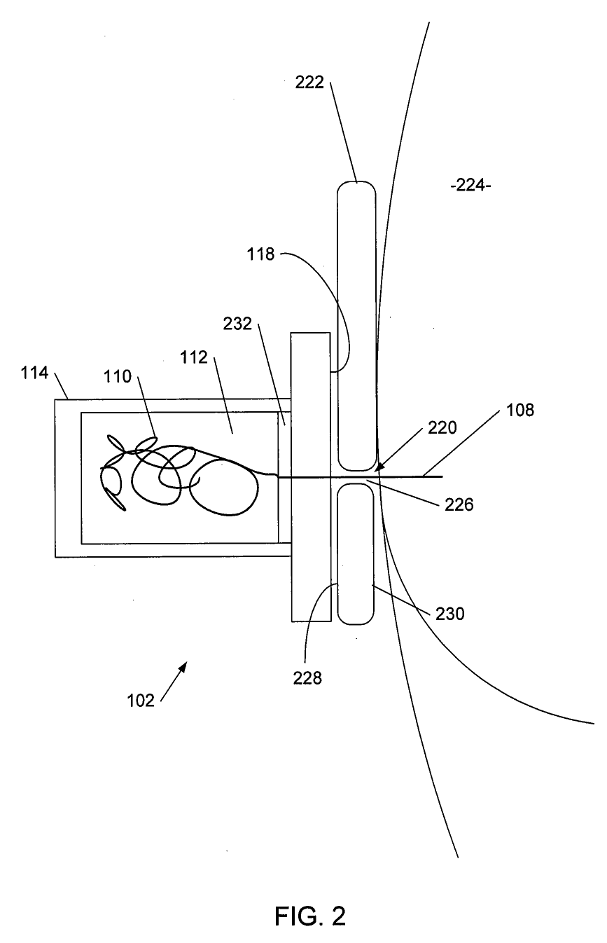

FIG. 2 is a cross-section view of the FIG. 1 cleaning apparatus 102, illustrating the internal construction of the apparatus and showing the cleaning apparatus adjacent a body piercing 220 to be cleaned. FIG. 2 shows a body piercing 220 comprising a piercing through the ear lobe 222 of a person, viewed from behind the person's head 224. It should be understood that the apparatus 102 can be used with a wide variety of body piercings through different body locations, such as through an ear lobe, eyebrow, nose, or the like.

The body piercing 220 includes a channel 226 through the skin, and is approached from one side 228 with the cleaning apparatus 102, which is sized so that it cannot pass through the piercing channel. The grip 114 of the cleaning apparatus 102 can be grasped by a user in one hand and used to guide the applicator proximal end 108 into the body piercing channel 226 from the first side 228 of the piercing 220 and out through a second side 230 of the body piercing such that the proximal end 108 extends through the piercing channel 226 and can be grasped from the second side 230 and pulled from the grip 114 by the user. The substantially flat surface 118 of the apparatus is preferably provided so it is presented to the piercing side 228 and blocks any contact by the user with the channel 226 during use, thereby enhancing cleanliness.

In the embodiment illustrated in FIG. 1 and FIG. 2, the applicator distal portion 110 is kept within the grip 114 until use, when the distal end is pulled away from the grip, thereby withdrawing the applicator 108,110 from the grip. While in the grip, the applicator distal portion 110 is bathed or coated in the treatment 112, such that the treatment is received or distributed on the applicator. The treatment can comprise, for example, a cleaning solution or medicated substance or antiseptic ingredient. The FIG. 2 embodiment includes a membrane 232 or other seal that keeps the treatment 112 contained within the grip 114 but lets the applicator 106 pass through, thereby maintaining sterility of the applicator. The membrane can include a single passage or opening through which the applicator 110 passes and which is aligned with a passage or opening through the apparatus 114. The treatment 112 is carried on the applicator 106 as the applicator is pulled from the grip 114 and is passed through the piercing channel 226. The applicator is sized according to the piercing to be cleaned so that, as the applicator is pulled through the piercing channel 116, the treatment 112 on the applicator is distributed into the piercing channel 118 and transferred onto the skin defining the channel.

To use the cleaning apparatus 102 illustrated in FIG. 1 and FIG. 2, the sterile packaging 104 is opened, the apparatus is removed, and the applicator stiff proximal end 108 is inserted through the piercing channel 226. The proximal end 108 is pulled through the piercing, extending the applicator distal portion 110 out the grip 114 and cleaning the piercing channel and depositing the treatment 112 on the channel. The used apparatus 102 is then disposed of properly.

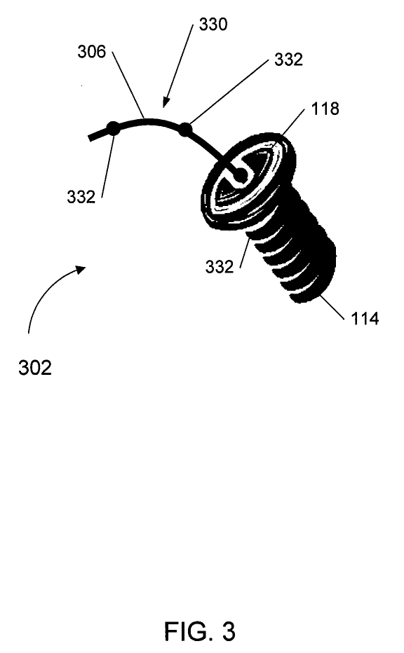

FIG. 3 is an illustration of another embodiment of the cleaning apparatus, shown in phantom. The FIG. 3 embodiment 302 is similar in construction to the FIG. 1 and FIG. 2 embodiments, but is illustrated with several features that are not illustrated in FIG. 1 and FIG. 2. One difference is that the FIG. 3 embodiment 302 utilizes a length of applicator 306 that is coiled within the grip 114 to conform to the general cylindrical shape of the grip. That is, the applicator is not simply packed into an internal cavity of the grip in a random fashion, as was illustrated in FIG. 2. Another difference shown in FIG. 3 is an alternative embodiment of the relatively stiff proximal end of the applicator. In FIG. 3, the applicator has a curved end 330, in contrast to the straight section of the proximal end 108 illustrated in FIG. 1 and FIG. 2. It should be understood, however, that the FIG. 1 apparatus and FIG. 2 apparatus can be provided with the curved end 330 applicator, and the FIG. 3 embodiment can be provided with the straight end 108 applicator. It also should be understood that any one of the apparatus configurations described in this document can be provided with either the straight proximal end or the curved proximal end. The FIG. 3 embodiment also includes a membrane 324 to contain the treatment inside the grip and maintain sterility of the applicator. The membrane helps prevent leakage of the treatment outside of the apparatus and helps prevent ingress of contaminants.

Another difference in the FIG. 3 embodiment is that the applicator is provided with protuberances 332 that extend outwardly from the applicator 306 and can make contact with the skin surfaces of the piercing channel 226, thereby promoting cleaning of the channel 220 and deposition of the treatment. The protuberances 332 serve to help retain the treatment on the applicator, by providing additional surfaces against which the treatment can be deposited or temporarily adhered, and the protuberances serve to help brush against or scrape the internal surfaces of the channel 220, thereby dislodging dirt or other contaminants that can detract from cleanliness and that can inhibit healing. The size, shape, and spacing of the protuberances 332 on the applicator 330 will be varied according to factors such as the intended size of body piercing, the treatment to be applied, and intended use of the apparatus.

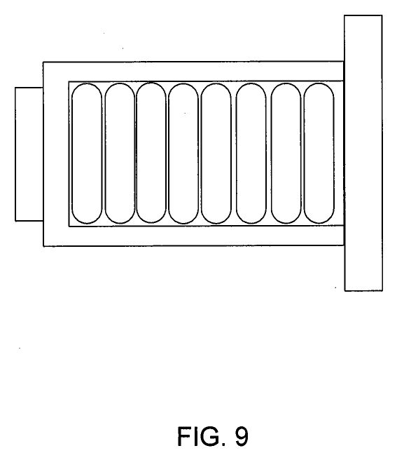

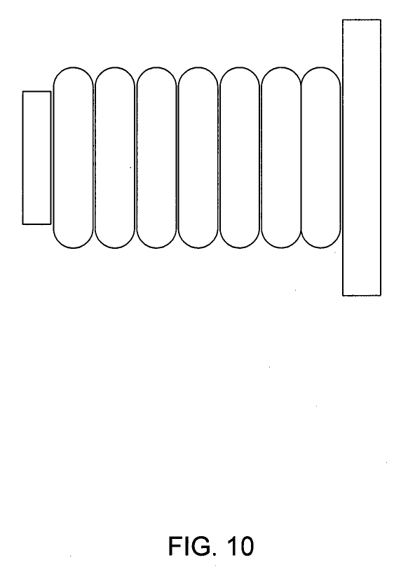

The coiled applicator 302 shown in FIG. 3 will generally be deployed from the grip 114 with a more smooth action and more linear resistance to pulling as compared with the randomly packed applicator illustrated in FIG. 2. The coiling of the applicator can be achieved in at least two configurations: (1) the applicator can be coiled on itself within a cylindrical grip so adjacent loops of the applicator are generally in contact with each other, or (2) the applicator can be contained within a conduit or tubing, and the applicator-containing tubing can be coiled on itself within a cylindrical grip or coiled around the outside of a cylindrical grip so that loops of the tubing can be adjacent each other. FIG. 9 is an illustration of an apparatus 902 with the applicator 110 coiled within the cylindrical grip 114, and FIG. 10 is an illustration of an apparatus 1002 that has the applicator (not visible) contained within tubing 1010, which is coiled so that loops of the tubing are adjacent each other. The tubing 1010 can be coiled around the outside surface of the cylindrical grip, and the tubing can be constructed from a transparent material, so that characteristics of the treatment can be readily observed by simple inspection of the apparatus 302. In both cases, the applicator itself will be threaded through an opening in the surface 118 of the apparatus.

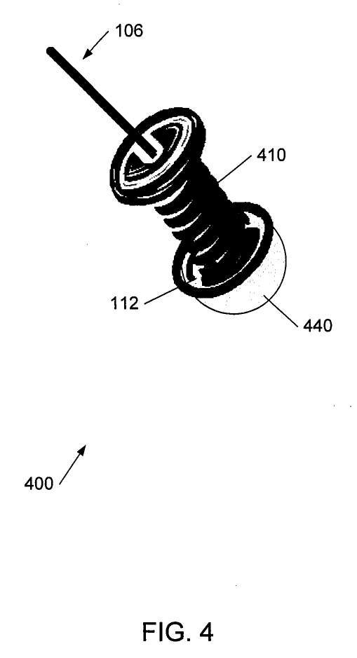

FIG. 4 is a perspective view of a cleaning apparatus embodiment 400 with a release for the treatment. The FIG. 4 embodiment does not maintain the applicator within the grip in a bath of treatment, such as was illustrated in FIG. 2. Rather, in FIG. 4, the applicator 110 is coiled within the cylindrical grip 410 as illustrated in FIG. 9, and the treatment 112 is carried within the grip 410 but is not released onto the applicator until a release mechanism is triggered. In the FIG. 4 embodiment, the release mechanism is provided as a button 440 on one end of the grip 114. When a user actuates the button 440, the treatment 112 is released into the applicator that is carried within the grip. The treatment is received onto the applicator 108 and then is deposited in the piercing channel, as was described above for the FIG. 1, FIG. 2, and FIG. 3 embodiments.

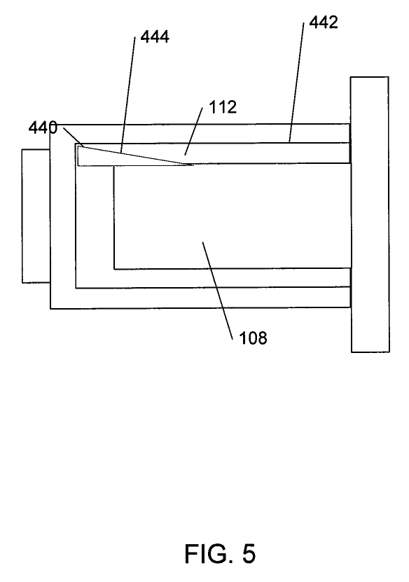

FIG. 5 is a sectional view of the FIG. 4 embodiment to show the internal structure. Internally, the treatment 112 is contained within a bladder 442. The applicator is coiled within the grip and the bladder is disposed within the grip. The treatment is maintained within the grip 114 by the bladder and membrane 232 and is received onto the applicator for cleaning the piercing channel as described previously above. The button 440 is coupled to a slidable tab or ridge 444 that can slide relative to a sealed pack or bladder 442 containing the treatment. When the tab 444 slides with the button 440, the tab tears or punctures the bladder 442, opening the bladder and permitting the treatment to be deposited onto the applicator. Alternatively, the bladder 442 can be provided with pre-stressed seams or the like, so that the slidable tab can be pressed against the bladder with movement of the button 440 to open the pre-stressed seam and expel the treatment from the bladder and onto the applicator. In the latter configuration, the tab can be blunt-shaped.

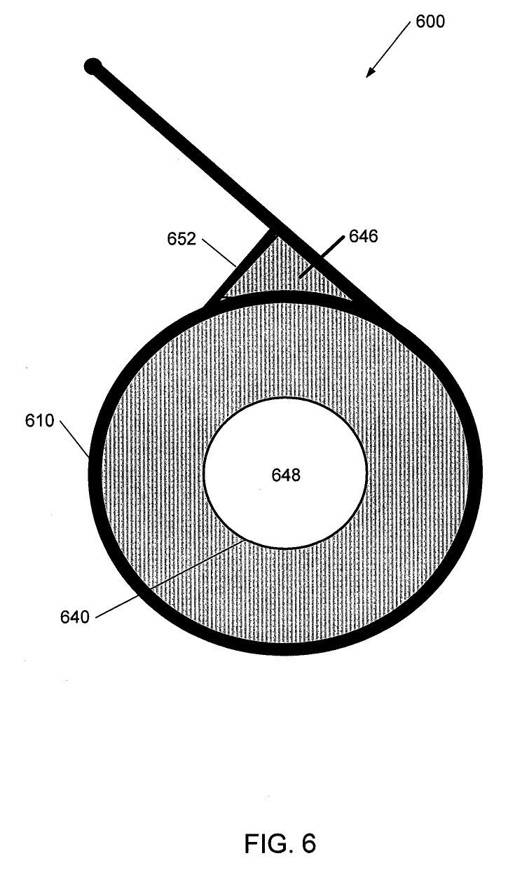

FIG. 6 is a perspective view of another cleaning apparatus embodiment 600. The FIG. 6 embodiment 600 has a grip 610 with a torus shape and a stiff applicator distal end that extends from the grip, with a flexible proximal portion attached to the distal end. The FIG. 6 embodiment includes a release mechanism 640 for the treatment, which is carried within the grip in a bladder. The FIG. 6 embodiment also includes a finger guard 646 that aids in handling the apparatus 600 and guiding the distal end into the piercing channel. The release mechanism 640 is preferably provided as a compressible mechanism that extends through the diameter (thickness) of the grip. Thus, the release mechanism includes two opposed ends 648, 650 that can be pressed between a user's thumb and forefinger to release the treatment onto the applicator. The applicator can then be withdrawn from the applicator and pulled through the piercing channel, as with operation of the other embodiments described above. A substantially flat surface 652 of the finger guard 646 serves a similar function to the surface 118 of the prior embodiments for maintaining sterility of the piercing channel and applicator during use.

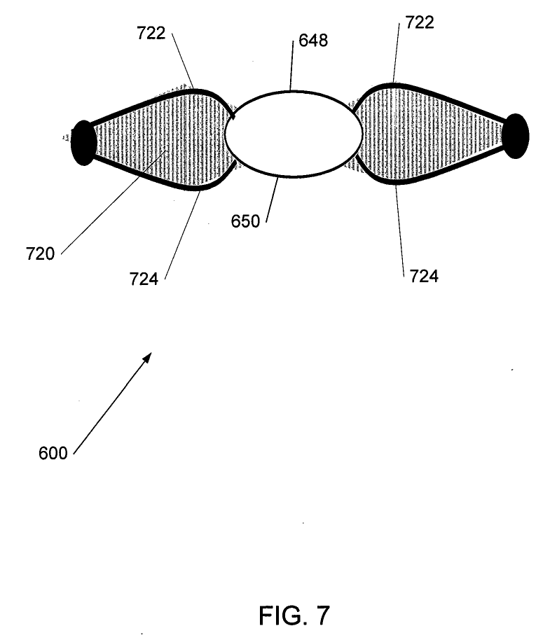

FIG. 7 is a cross-section view of the FIG. 6 apparatus 600 showing the internal treatment bladder 720 and internal mechanism of the release. In the FIG. 7 illustration, the treatment 112 within the bladder is indicated by shading. Pressing the release mechanism 648, 650 expels the treatment from the bladder, either by tearing or puncturing the bladder, or by forcing the treatment out of the bladder from pre-stressed seams or the like, in a fashion similar to that described above in conjunction with FIG. 5. The apparatus 600 also includes raised outer surfaces 720, 722 of the grip that help prevent accidental actuation of the release mechanism. The raised surfaces on either side of the grip are configured such that the raised surfaces form a plane through which an accidental pressure is difficult to apply. That is, a relatively deliberate pressure applied directly to the button surfaces 648, 650 is necessary to actuate the mechanism, and therefore the chance of accidental actuation, such as by jostling when the applicator is being carried about, is unlikely.

All of the embodiments described thus far provide a disposable cleaning apparatus that is maintained sterile and then is disposed of after use. If preferred, a reusable holder can be provided to receive a disposable embodiment of the cleaning apparatus. For example, a holder can be provided that opens to receive the disposable cleaning apparatus described above in any of FIGS. 1 through 7. Preferably, the sterile packaging can be maintained within the holder, or the holder itself can provide a sterile environment for the disposable apparatus. After the disposable apparatus has been inserted into the holder, the stiff proximal end is guided through the piercing channel and the applicator is extended from the holder and grip combination through the piercing channel. After the inserted apparatus has been used, the reusable holder can be opened and the spent apparatus grip inside can be disposed of, as before.

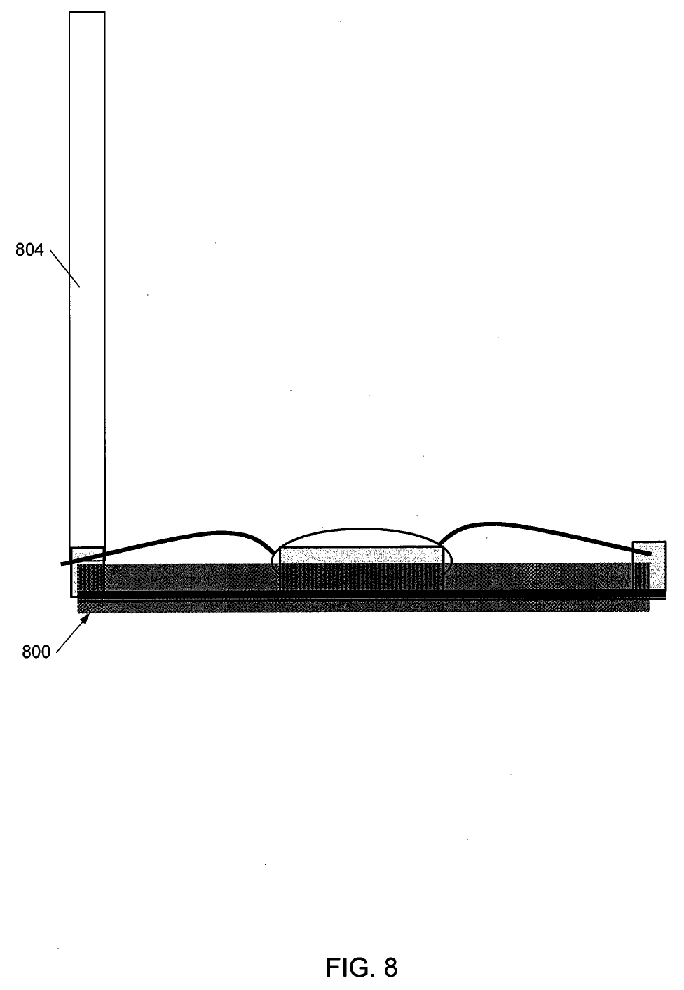

FIG. 8 shows an embodiment of a holder 800 that can receive the FIG. 6 and FIG. 7 configuration of cleaning apparatus. The FIG. 8 holder has a shape like that of the torus-shaped embodiments and is configured similarly to a makeup “compact” that contains face powder or the like. In the FIG. 8 embodiment, however, the “compact” receives a disposable cleaning apparatus. The reusable holder 800 can be provided with a design or appearance that is decorative and aesthetically pleasing, thus promoting acceptance of the cleaning apparatus as a consumer hygiene product. The reusable holder preferably has a hard outer surface that is sufficiently strong to resist moderate forces, such as would typically be encountered if carried with a purse or backpack. In this way, the portability of the cleaning apparatus is improved and accidental destruction or compromising of the sterility prior to use will be avoided.

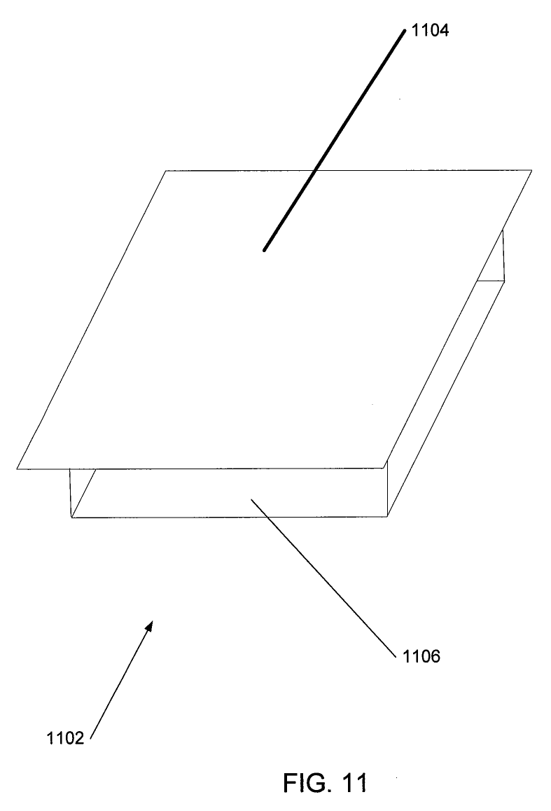

FIG. 11 shows a “foil pack” embodiment 1102 constructed for convenient usage within the compact or holder illustrated in FIG. 8. A foil backing 1104 encloses a blister pack 1106 that contains an applicator and treatment combination such that fitting the foil pack into the compact (FIG. 8) permits the foil pack to be carried within the compact and maintained sterile until use. When use is desired, the compact can be opened and the applicator can be withdrawn from the foil pack as described above. If desired, a release can be incorporated into the compact such that the treatment can be carried in a bladder within the blister pack separately from the applicator, as described above. Actuating the release will release the treatment onto the applicator.

The cleaning apparatus described herein provides a convenient means for maintaining hygiene of body piercings. Sterility of the cleaning apparatus is maintained by suitable packaging. The packaging for the cleaning apparatus can comprise sealed foil packs or other easily opened packs that maintain a seal against outside contaminants. The packaging can be provided with coding to indicate configurations with different sizes for different piercings. For example, package colors or legends can be selected to use one color for body piercings having a channel up to a predetermined diameter, and packages of a different color can be used for body piercings having a channel with a different predetermined diameter. If desired, the color of the cleaning apparatus may be given a corresponding color, to indicate the same size differences.

The present invention has been described above in terms of a presently preferred embodiment so that an understanding of the present invention can be conveyed. There are, however, many configurations for the system and application not specifically described herein but with which the present invention is applicable. The present invention should therefore not be seen as limited to the particular embodiment described herein, but rather, it should be understood that the present invention has wide applicability with respect to multi-user applications generally. All modifications, variations, or equivalent arrangements and implementations that are within the scope of the attached claims should therefore be considered within the scope of the invention.

I claim:

1. A cleaning apparatus for a body piercing, the apparatus comprising:
an elongated applicator having a substantially rigid proximal end;
a treatment to be applied to the applicator; and
a grip through which the applicator proximal end extends such that the grip can be grasped and used to guide the applicator proximal end from one side of the body piercing through a channel of the piercing to a second side of the body piercing such that the applicator proximal end can be grasped from the second side and pulled from the grip;
wherein the treatment is contained in the grip such that the applicator receives the treatment, and the applicator is sized so the received treatment is applied to the body piercing as the applicator is pulled through the body piercing.

2. A cleaning apparatus as defined in claim 1, further including:
a bladder that contains the treatment in a sealed condition apart from the applicator; and
a release mechanism that initiates application of the treatment to the applicator such that the applicator pulled from the grip includes the treatment.

3. A cleaning apparatus as defined in claim 2, wherein the release mechanism comprises a button that opens the bladder and releases the treatment onto the applicator within the grip.

4. A cleaning apparatus as defined in claim 2, wherein the button comprises a ridge that tears open the bladder when the button is pressed.

5. A cleaning apparatus as defined in claim 1, wherein the applicator includes a relatively stiff proximal end that extends from the grip and a relatively flexible distal portion that resides within the grip until pulled from the grip by the user.

6. A cleaning apparatus as defined in claim 5, wherein the flexible distal portion of the applicator is coiled within the grip to conform to the grip.

7. A cleaning apparatus as defined in claim 1, wherein the grip has a cylindrical outer shape.

8. A cleaning apparatus as defined in claim 7, further including:
a bladder that contains the treatment in a sealed condition apart from the applicator;
a release mechanism that initiates application of the treatment to the applicator such that the applicator pulled from the grip includes the treatment;
a bladder that contains the treatment in a sealed condition apart from the applicator; and
a release mechanism that initiates application of the treatment to the applicator such that the applicator pulled from the grip includes the treatment.

9. A cleaning apparatus as defined in claim 8, wherein the release mechanism comprises a button that opens the bladder and releases the treatment onto the applicator within the grip.

10. A cleaning apparatus as defined in claim 1, wherein the grip has a torus outer shape.

11. A cleaning apparatus as defined in claim 10, further including:
a bladder that contains the treatment in a sealed condition apart from the applicator;
a release mechanism that initiates application of the treatment to the applicator such that the applicator pulled from the grip includes the treatment;
a bladder that contains the treatment in a sealed condition apart from the applicator; and
a release mechanism that initiates application of the treatment to the applicator such that the applicator pulled from the grip includes the treatment.

12. A cleaning apparatus as defined in claim 11, wherein the release mechanism comprises a button that opens the bladder and releases the treatment onto the applicator within the grip.

13. A cleaning apparatus as defined in claim 1, wherein the applicator includes protuberances to promote cleaning of the piercing channel.

14. A cleaning apparatus as defined in claim 1, further including:
a sterile packing that receives the grip and maintains the grip in a sterile environment.

15. A cleaning apparatus as defined in claim 1, further including:
a reusable holder that receives the grip and can be closed around the grip to protect the grip from moderate forces.

16. A method of maintaining body piercing hygiene, the method comprising:
grasping a cleaning apparatus by a grip and positioning the apparatus near a body piercing;
inserting a substantially rigid applicator proximal end of the cleaning apparatus through the body piercing, such that the applicator proximal end is inserted from one side of the body piercing through a channel of the piercing to a second side of the body piercing;
grasping the applicator proximal end from the second side and pulling the applicator from the grip and through the body piercing;
wherein treatment is contained in the grip such that the applicator receives the treatment, and the applicator is sized so the received treatment is applied to the body piercing as the applicator is pulled through the body piercing.
